(19) United States
(12) Patent Application Publication
(10) Pub. No.: US 2019/0047478 A1
(43) Pub. Date: Feb. 14, 2019

(54) PROTECTIVE DEVICE FOR A VEHICLE INTERIOR

(71) Applicants: William POMPILI, Shelby Township, MI (US); Ed STEINMETZ, Lapeer, MI (US); Jürgen SALEWSKI, Rochester Hills, MI (US); Ralf GROCHOWSKI, Rochester Hills, MI (US)

(72) Inventors: William POMPILI, Shelby Township, MI (US); Ed STEINMETZ, Lapeer, MI (US); Jürgen SALEWSKI, Rochester Hills, MI (US); Ralf GROCHOWSKI, Rochester Hills, MI (US)

(21) Appl. No.: 16/056,867

(22) Filed: Aug. 7, 2018

Related U.S. Application Data
(60) Provisional application No. 62/542,532, filed on Aug. 8, 2017.

(51) Int. Cl. B60R 5/04

(52) U.S. Cl. CPC B60R 5/048

(57) ABSTRACT

Protective device for a vehicle interior with a flexible protective structure, which can be moved between a position of rest compactly stowed in the region of a supporting structure and a deployed protection position, with a dimensionally stable end profile which is provided at a front end region of the protective structure in the deployment direction The protective structure is formed as a folded leporello structure from a plurality of profile sections extending transversely to the deployment direction and adjoining each other in the deployment direction and joined together by fold lines.

### CROSS-REFERENCE TO RELATED APPLICATIONS

This claims the benefit of U.S. Provisional Application No. 62/542 532, filed Aug. 8, 2017, the disclosure of which is hereby incorporated by reference in its entirety.

### TECHNICAL FIELD

The invention relates to a protective device for a vehicle interior, especially for a cargo space of a motor vehicle, with a flexible protective structure, which can be moved between a position of rest compactly stowed in the region of a supporting structure and a deployed protection position, with a dimensionally stable end piece which is provided at a front end region of the protective structure in the deployment direction.

### BACKGROUND

Such a protective device is generally known in the form of a cargo space cover for a passenger car. The known cargo space cover has a weblike sheet structure, which is held on a winding shaft and can be rolled up and rolled out. The winding shaft is pivoted in a cassette housing, which can be secured in the cargo space. The planar sheet structure is provided with a dimensionally stable end piece at its front end region in the deployment direction, which is shaped as a contour piece. The contour piece has a suspension pin at each of the opposite side regions, which sticks outward transversely to the deployment direction of the sheet structure, and which can be secured by hanging from a supporting seat fixed to the cargo space of the vehicle in the deployed protection position of the sheet structure.

### SUMMARY

The problem which the invention proposes to solve is to create a protective device of the kind mentioned above, which is simple in its construction and has only a slight weight.

This problem is solved in that the protective structure is formed as a folded leporello structure from a plurality of profile sections extending transversely to the deployment direction and adjoining each other in the deployment direction and joined together by fold lines. The profile sections may be in the form of strips extending transversely to the deployment direction. Alternatively, according to one advantageous embodiment, the profile sections may be configured as hollow profile cells, especially ones which are open at opposite sides, which extend transversely to the deployment direction across the width of the folded structure. Preferably each hollow profile cell can be converted into an extension oriented upright relative to a deployment plane of the folded structure or in a longitudinally oriented extension. This necessarily produces a corresponding change in the length of the folded structure in the deployment direction, such that the compact stowed (compressed) position of rest or the lengthwise deployed protection position can be achieved. The solution according to the invention is especially advantageously suited for a cargo space cover of a passenger car which can be deployed roughly horizontally. The solution according to the invention can be used likewise for other kinds of protective devices as a sun screen for glass roof areas or as a sun screen for side or rear windows. The configuration of the profile sections as hollow profile cells is especially advantageous, since in this way the natural stability of the folded structure in the deployed protection position is significantly increased. This prevents a buckling of the folded structure in the deployed protection position when the folded structure has a roughly horizontal orientation.

In another embodiment of the invention, two layers of striplike profile sections are provided, one on top of the other and folded in opposite zig zag shape, being joined to each other at their mutually facing fold lines to produce folded rectangular hollow profiles in cross section, which are open at opposite situated end faces transversely to the deployment direction. The folded hollow profiles form hollow profile cells in the sense of the invention. The at least two layers of striplike profile sections provided one on top of the other and folded in pairs in opposite zig zag shape are joined to each other continuously across their entire length in the region of the fold lines, the length of the profile sections extending transversely to the deployment direction. The rectangular shape of the folded hollow profiles in cross section produces squares or vertically extending or lengthwise extending diamond shapes, depending on the displacement of the folded structure. The angular configuration of these hollow profile cells further enhances the stability of the folded structure. Thanks to the stability achieved, no lateral guidance is needed for the folded structure.

In another embodiment of the invention, the profile sections of the superimposed layers have different configuration. While the profile sections of the superimposed layers are likewise strip-shaped, they have different configuration from each other in their width. All the profile sections of the first layer and all the profile sections of the second layer are designed identical to each other and accordingly are only different with respect to the other layer.

In another embodiment of the invention, the profile sections of a top layer are configured such that the profile sections in the deployed protection position are at least for the most part flush with each other in the deployment direction to form an at least largely planar surface. This embodiment is especially advantageous when using the protective device as a cargo space cover, because then when looking at the deployed cargo space cover from above it gives the impression of an at least largely planar surface, whereas the corresponding hollow profile cells still produce a high stability, so that the folded structure can make do with no lateral guidance in the region of the hollow profile cells. In this embodiment, the profile sections of the top layer have a lesser width—looking in the deployment direction—than the profile sections of the layer situated underneath. Because the profile sections of the lower layer are larger in dimension, they still remain in a V-shape when the profile sections of the top layer are already almost fully stretched out.

In another embodiment of the invention, the folded structure is made from a plastic film material, especially one that is fiber-reinforced, or a cellulose material, especially one that is fiber-reinforced. The material for the folded structure is preferably non-flammable.

In another embodiment of the invention, at least one elastic tension cord is stretched through the folded structure in the deployment direction, which is secured at one end in the region of the supporting structure and at the other end in the region of the dimensionally stable end profile, such that a tensile force is permanently exerted on the end profile in the return direction. The at least one elastic tension cord is consequently stretched and tensioned in each position of the folded structure. Preferably, at least two tension cords are provided, oriented parallel to each other. The tension cord consists of an elastomer material or comprises elastomer components. The tension cord preferably has a uniform cross section along its length. This cross section may be stretched lengthwise when the tension cord is configured as a band, or round when the tension cord is configured as a cable. The tension cord is advantageously configured such that the tension cord can be pulled out to at least twice its length and again return elastically to the original position after the tension stress is removed. Preferably, a rubber cable is provided as the elastomer cable.

In another embodiment of the invention, holding elements are coordinated with the end piece in order to be able to secure the end piece in the deployed protection position of the protective structure in the vehicle interior. The holding elements are preferably configured as holding pins sticking out from opposite sides of the end piece transversely to the deployment direction. These holding pins may be hung from or inserted or locked in holding seats in the vehicle interior.

In another embodiment of the invention, a mechanical adjusting device is provided for adjusting a tensile force or pull length of the at least one elastic tension cord. The mechanical adjusting device is preferably realized by a mechanical clamping element for the at least one tension cord, which is supported on the supporting structure. In this way, the tension cord can be pulled out to a desired length when mounting the protective device and clamped at this length under permanent pretensioning of the stretched out tension cord, securing the folded structure in its position of rest yet still allowing the folded structure to be pulled out into its protection position. The at least one clamping element is configured such that a repeated pulling out and retracting of the folded structure can be done without losing the permanently acting tensile force of the at least one tension cord.

In another embodiment of the invention, the dimensionally stable end piece has a securing device to secure the end piece in the position of rest of the protective structure in a space-saving position of rest on the supporting structure. If the folded structure is being used for a roughly horizontally deployable cargo space cover or for a likewise roughly horizontally deployable glass roof sun screen, the end piece may be attached in a roughly vertical orientation to a front end of the supporting structure, in order to accomplish the space-saving orientation of the end piece. This embodiment is especially advantageous for use in a roughly horizontally deployable cargo space cover, since in such a cargo space cover the end piece is configured as a large-surface contour piece, in order to close the gap between a front end region of the folded structure and a rear bodywork part. Thanks to the upright orientation of the end piece in the position of rest, preferably by the end piece pointing downward, the cargo space is hardly impaired in its cargo capacity by the end piece.

In another embodiment of the invention, the securing device has mutually complementary profilings on an underside of the end profile on the one hand and a front end of the supporting structure on the other hand. The mutually complementary profilings enable a releasable locking or clamping of the end profile in its space-saving position of rest at the front end of the supporting structure.

In another embodiment of the invention, the securing device has adhesive elements which are active in the position of rest of the end profile between the supporting structure and the end piece. Such adhesive elements are preferably configured as permanent magnets, Velcro strips, or adhesive strips.

### BRIEF DESCRIPTION OF THE DRAWINGS

Further benefits and features of the invention will emerge from the claims, as well as the following description of a preferred sample embodiment of the invention, represented with the aid of the drawings.

FIG. 1 shows in a perspective exploded drawing one embodiment of a protective device according to the invention,

FIG. 2 the protective device of FIG. 1 in a deployed protection position,

FIG. 3 the protective device of FIGS. 1 and 2 in a compact stowed position of rest,

FIG. 4 in a side view, the protective device of FIGS. 1 to 3 in the deployed protection position,

FIG. 5 the protective device of FIG. 4, but in an intermediate position between the position of rest and the protection position,

FIG. 6 the protective device of FIG. 3 in a side view,

FIG. 7 the protective device of FIG. 6, omitting one side flap of a supporting structure,

FIG. 8 in enlarged representation, a partial region of the protective device per FIGS. 1 to 7,

FIG. 9 the representation of FIG. 8, leaving out the supporting structure,

FIG. 10 the representation of FIG. 9, leaving out a dimensionally stable end piece and an elastic tension cord,

FIG. 11 a partial representation showing the guidance and securing of a tension cord in the region of a rear holding plate of a folded structure of the protective device per FIGS. 1 to 10,

FIG. 12 schematically, a folded structure according to another embodiment of a protective device according to the invention and

FIG. 13 the folded structure in the stretched state.

### DETAILED DESCRIPTION

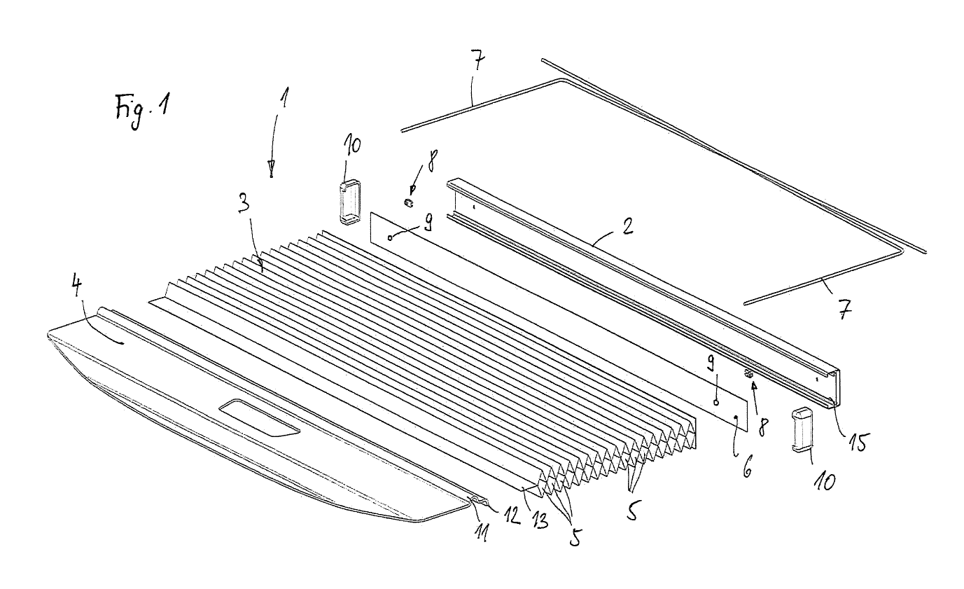

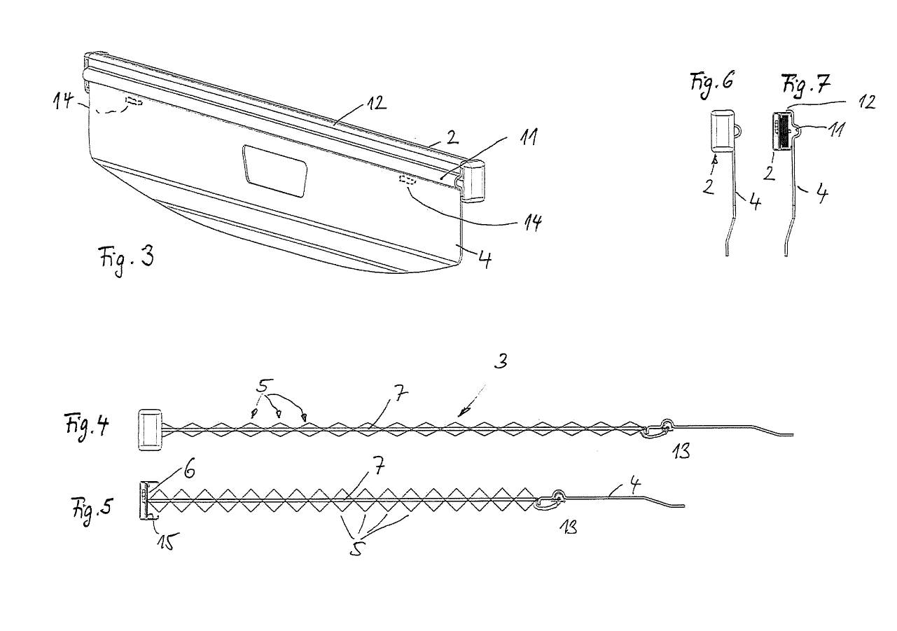

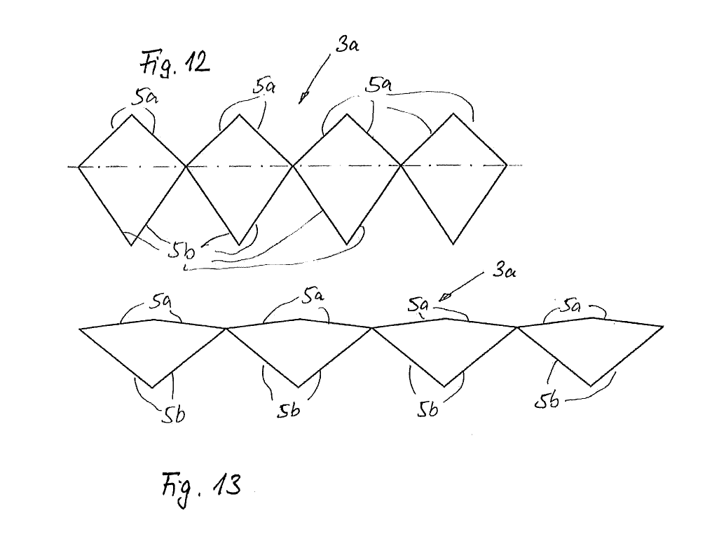

A protective device according to FIGS. 1 to 11 constitutes a roughly horizontally deployable cargo space cover for a passenger car. The cargo space cover is situated in a basically known manner in a vehicle interior of the passenger car and positioned firmly in the vehicle, behind a back rest of a rear bench seat in the cargo space. The cargo space cover is oriented roughly at the height of a vehicle breastwork and extends in the vehicle transverse direction between two oppositely situated side breastworks of the vehicle interior of the passenger car.

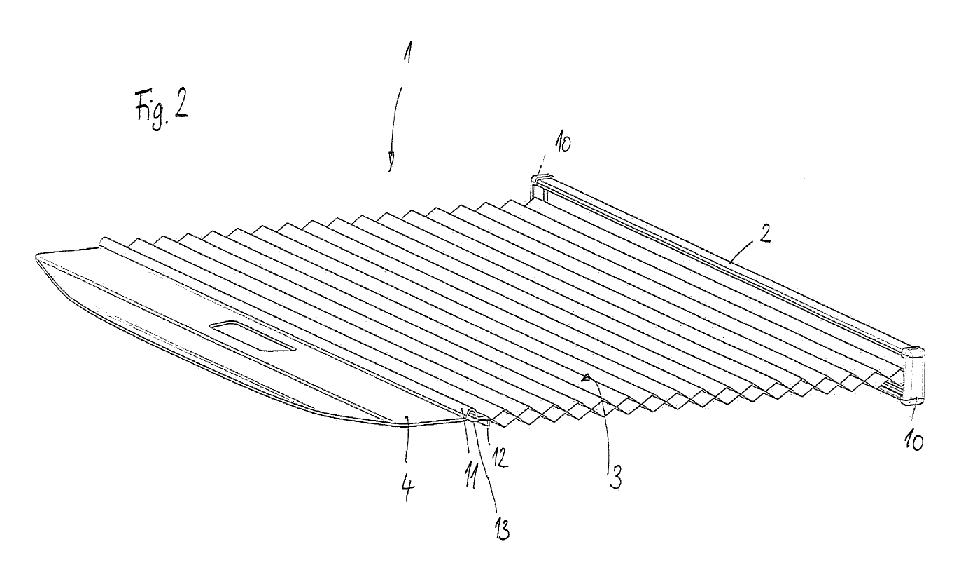

The cargo space cover 1 has a flexible protective structure in the form of a folded leporello structure 3, which can be moved between a position of rest (FIGS. 3 and 6, 7) and a protection position deployed roughly horizontally to the rear of the vehicle (FIGS. 2 and 4). The folded structure 3 is fastened at the rear—in the deployment direction—to a dimensionally stable holding plate 6, which is held in a manner to be described more closely below in a supporting structure 2 in the form of a dimensionally stable support profile, extending transversely to the deployment direction. The folded structure 3 has a front strip 13 at its front end region in the deployment direction, which is secured to a dimensionally stable end piece 4, formed as a large-surface contour piece with a recessed grip. Advantageously, the front strip 13, which is part of the folded structure 3, is joined to a cross bar of the end piece 4.

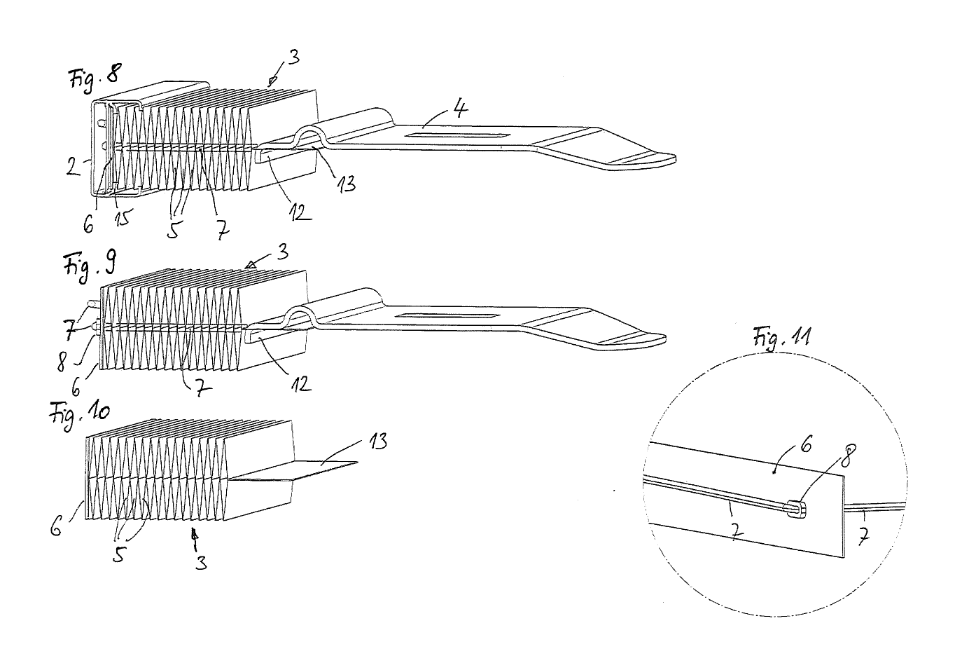

The folded structure 3 is composed of a multitude of hollow profile cells 5, having rectangular cross sections and extending transversely to the deployment direction across the width of the folded structure 3. The hollow profile cells 5 are formed by two superimposed layers of zig zag extending and strip-shaped profile sections, the multitude of strip-shaped profile sections of each layer being connected each time to the adjacent profile section along a fold line extending transversely to the deployment direction. The fold lines of each of the two layers of strip-shaped profile sections form alternating upper and lower fold edges, each time two neighboring fold edges in the vertical direction of the superimposed layers of profile sections abutting against each other for the entire length of the profile section and being joined together firmly and continuously in this region. The respective fold lines form film hinges, by which the hollow profile cells 5 can be stretched out or collapsed (see FIGS. 4 and 5). In this way, the hollow profile cells form rectangles in cross section in the form of diamond shapes or in the form of squares, depending on whether fully or partly deployed, wherein the diamond shapes in the fully deployed protection position extend lengthwise in the deployment plane (FIG. 4) and are stretched vertically by their largest width in or near the position of rest (FIG. 8).

The folded structure 3 has two elastic tension cords 7 passing through it in the deployment direction, which run through a flight of holes in the neighboring hollow profile cells 5 in the deployment direction and are secured at the front strip 13 of the folded structure 3 at the front in the deployment direction, preferably by stitching. The two tension cords 7 pass centrally through the hollow profile cells 5, i.e., in the region of the middle fold lines, by which the upper layer of strip-shaped profile sections and the lower layer of strip-shaped profile sections of the folded structure 3 are joined together.

It can be seen in FIGS. 4 to 11 that each of the two tension cords 7 is secured at the front to a cross bar in the region of the end piece 4, which is firmly connected to the end piece 4, and that each tension cord is led toward the rear in the deployment direction through the folded structure 3 and through a respective passage 9 in the holding plate 6. The holding plate 6 is coordinated at the rear side of the respective passage 9 with a respective clamping element 8, through which the respective tension cord 7 is likewise threaded. Each clamping element 8 has a wedge-shaped narrowing clamping section at the side of the through hole for the threading of the tension cord 7, into which the respective tension cord 7 is pulled with a right-angled deflection and corresponding applying of a suitable tensile force. The pulling through produces the forced clamping and securing of the tension cord 7 in the respective clamping element 8.

In order to mount the folded structure 3 in place, the two tension cords 7 are attached to the cross bar of the end piece 4, threaded through the respective flight of holes inside the hollow profile cells 5 of the folded structure 3 toward the rear, and led through the respective passage 9 in the holding plate 6. After this, the two tension cords 7 are pulled manually until the folded structure 3 has reached its compact position of rest, in which the hollow profile cells 5 lie against each other as a block in the deployment direction (see FIG. 7). The two tension cords 7 can now be pulled backward and secured to the respective clamping elements 8, which are braced at the rear by the holding plate 9. This block of the folded structure 3 is then shoved together with the end piece 4 from one open end face of the hollow profile of the supporting structure 2 into the hollow profile, the holding plate 6 being shoved into a corresponding longitudinal groove 15 of the hollow profile of the supporting structure 2. The longitudinal groove is bounded at the rear by a reinforcing wall of the supporting structure, not otherwise shown. The corresponding longitudinal groove 15 secures the holding plate 6 by positive locking in the deployment direction and accordingly forms a reliable support for a secure fixation of the holding profile 6 in the supporting structure 2. After this, corresponding side flaps 10 may be mounted on the opposite end faces of the supporting structure 2, by which the holding plate 6 and thus also the folded structure 3 is secured against shifting in the lengthwise direction of the supporting structure 2.

The two tension cords 7 in the sample embodiment shown are provided as elastomer cables with a round cross section, especially as rubber bands or rubber cables.

The end piece 4 in the deployed protection position of the folded structure 3 may be suspended from support seats fixed to the vehicle. For this, the end piece 4 has a trough-shaped profiling 11 extending across the entire width of the end piece 4 transversely to the deployment direction, in which the cross bar is placed and secured, not being otherwise shown in FIGS. 1 to 11. The cross bar forms respective holding pins sticking out to the side beyond the respective side edge of the end piece 4, which can be suspended from the support seats fixed to the vehicle in order to secure the end piece 4 in the deployed protection position of the folded structure 3. The end piece 4 in this suspended attachment position is oriented as shown in FIG. 2.

The end piece 4 furthermore has, in the region of the front strip 13 of the folded structure 3, a securing profiling 12 likewise extending over an entire width of the end piece 4, which can be hung in the position of rest of the end piece 4 from an upper edge of the supporting structure 2, not otherwise shown, so that the end piece 4 in the position of rest per FIGS. 3 and 6, 7 projects roughly vertically downward, parallel to the front end of the supporting structure 2. Thanks to the permanent tensile force of the tension cords 7, this vertically downward projecting and upper attached position of rest of the end piece 4 is already statically determined. In addition, per FIG. 3, adhesive elements 14 are further provided in the region of the front end of the supporting structure 2 and the underside (back side) of the end piece 4, which additionally releasably secure the end piece 4 in the vertically downward pointing position of rest. Such adhesive elements 14 are designed as permanent magnets, Velcro strips, or similar adhesive strips. Thanks to the permanent tensile force which the tension cords 7 exert on the end piece 4 in the direction of its position of rest, and thanks to the pivot axis defined by the securing profiling 12 in the area of the upper edge of the supporting structure 2, the tensile force of the tension cords 7 automatically and forcefully pulls the end piece 4 into the position of rest represented in FIGS. 3, 6 and 7 as long as there is no countervailing, external, manual load. The mere grabbing of the end piece 4 results in a loosening of the adhesive elements 14, and a subsequent pulling of the end piece 4 away from the supporting structure 2 in the deployment direction necessarily results in a releasing of the securing profiling 12 from the front edge of the supporting structure 2 and a deployment movement of the folded structure 3.

The folded structure 3a according to FIGS. 12 and 13 can be used for the protective device per FIGS. 1 to 11 in the same way as the folded structure 3 per FIGS. 1 to 11. Accordingly, tension cords are passed through the folded structure 3a in the same way as was done for the folded structure 3 per FIGS. 1 to 11. In order to avoid repetition, therefore, reference is made in addition to the description of the protective device per FIGS. 1 to 11. In the following, the differences between the folded structure 3a and the folded structure 3 shall be discussed. The major difference in the folded structure 3a is that a top layer of strip-shaped profile sections 5a has different dimensions from a lower layer of strip-shaped profile sections 5b to form the hollow profile cells. The two layers of strip-shaped profile sections 5a, 5b are each individually folded into a leporello and are connected in the region of the fold lines facing the other respective layer by an abutment with the fold lines of the lower layer. However, the profile sections 5b have a width—looking in the deployment direction—which is larger than a width of the strip-shaped profile sections 5a. Because the upper and the lower strip-shaped profile sections 5a and 5b are hinged together in the region of the fold lines to form film hinges, a stretching out of the folded structure 3a per FIG. 13 results in the upper layer of narrower profile sections 5a changing into an almost stretched orientation, in which the upper layer of profile sections 5a forms an almost planar surface. On the contrary, the layer of broad, lower profile sections 5b because of the larger dimensioning of the profile sections 5b is still in a zig zag folding, so that even when the profile sections 5a of the upper layer are stretched out the hollow profile cells still remain. However, in the stretched out position, corresponding to a deployed protection position of the folded structure 3a, a cross section of the hollow profile cells is substantially triangular and no longer rectangular. The tension cords, not shown, run similar to the above described embodiment along the plane defined by the film hinges between upper and lower layer of the folded structure 3a and represented by dash and dot line in FIG. 12.

1. A protective device for a vehicle interior, especially for a cargo space of a motor vehicle, with a flexible protective structure, which can be moved between a position of rest compactly stowed in the region of a supporting structure and a deployed protection position, with a dimensionally stable end piece which is provided at a front end region of the protective structure in the deployment direction, wherein the protective structure is formed as a folded leporello structure from a plurality of profile sections extending transversely to the deployment direction and adjoining each other in the deployment direction and joined together by fold lines.

2. The protective device as claimed in claim 1, wherein the profile sections are configured as hollow profile cells, which extend transversely to the deployment direction across the width of the folded structure.

3. The protective device as claimed in claim 2, wherein at least two layers of striplike profile sections are provided, one on top of the other and folded in pairs in opposite zig zag shape, being joined to each other at their mutually facing fold lines to produce folded rectangular hollow profiles in cross section, which are open at opposite situated end faces transversely to the deployment direction.

4. The protective device as claimed in claim 3, wherein the profile sections of the superimposed layers have different configuration.

5. The protective device as claimed in claim 4, wherein the profile sections of a top layer are configured such that the profile sections in the deployed protection position are at least for the most part flush with each other in the deployment direction to form an at least largely planar surface.

6. The protective device as claimed in claim 1, wherein the folded structure is made from a plastic film material, especially one that is fiber-reinforced, or a cellulose material, especially one that is fiber-reinforced.

7. The protective device as claimed in claim 1, wherein at least one elastic tension cord is stretched through the folded structure in the deployment direction, which is secured at one end in the region of the supporting structure and at the other end in the region of the dimensionally stable end piece, such that a tensile force is permanently exerted on the end piece in the return direction.

8. The protective device as claimed in claim 7, wherein holding elements are coordinated with the end piece in order to be able to hang up the end piece in the deployed protection position of the protective structure in the vehicle interior.

9. The protective device as claimed in claim 1, wherein a mechanical adjusting device is provided for adjusting a tensile force or pull length of the at least one elastic tension cord.

10. The protective device as claimed in claim 1, wherein the dimensionally stable end piece has a securing device to secure the end piece in the position of rest of the protective structure in a space-saving position of rest on the supporting structure.

11. The protective device as claimed in claim 10, wherein the securing device has mutually complementary profilings on an underside of the end piece on the one hand and a front end of the supporting structure on the other hand.

12. The protective device as claimed in claim 10, wherein the securing device has adhesive elements which are active in the position of rest of the end piece between the supporting structure and the end piecep.
